(19) United States
(12) Patent Application Publication
(10) Pub. No.: US 2026/0022738 A1
(43) Pub. Date: Jan. 22, 2026

(54) BEARING DEVICE WITH INTEGRATED ELECTRICAL INSULATION, IN PARTICULAR FOR A MOTOR OR AN ELECTRICAL MACHINE, AND ASSOCIATED PRODUCTION METHOD

(71) Applicant: AKTIEBOLAGET SKF, GOTEBORG (SE)

(72) Inventors: Benoit ARNAULT, Saint-Cyr-sur-Loire (FR); Mickael CHOLLET, Joué-Lès-Tours (FR)

(21) Appl. No.: 19/263,822

(22) Filed: Jul. 9, 2025

(30) Foreign Application Priority Data
Jul. 22, 2024 (FR) 2408027

(51) Int. Cl. F16C 41/00; F16C 19/06; F16C 43/06

(52) U.S. Cl. CPC F16C 41/002; F16C 19/06; F16C 43/06; F16C 2380/26

(57) ABSTRACT

A bearing device includes a ring having a cylindrical surface and first and second axially spaced end surfaces, a bushing, and an electrically insulating insert overmolded between and connecting the bushing and the cylindrical surface of the second ring. The bushing includes an cylindrical portion and a first annular flange extending radially from a first axial end of the cylindrical portion and a second annular flange extending radially from a second axial end of the cylindrical portion, and a portion of the ring is located axially between the first and second annular flanges. A minimum axial distance between the first annular flange and the second annular flange is greater than the maximum axial width of the ring, and the electrically insulating insert is overmolded onto the cylindrical portion and onto the first annular flange and onto the second annular flange and onto the ring.

### CROSS-REFERENCE

This application claims priority to French patent application no. 2408027 filed on Jul. 22, 2024, the contents of which are fully incorporated herein by reference.

### TECHNOLOGICAL FIELD

The present disclosure concerns the field of bearings used in particular in electric motors, electrical machines and associated equipment.

### BACKGROUND

In a motor or an electrical machine, at least one roller bearing is fitted between the housing of the motor or of the electrical machine and the rotary shaft, in order to support this shaft. In operation, when the shaft is rotating, a difference of electrical potential can appear between the shaft and the housing of the motor or of the electrical machine, which generates an electric current between the interior ring of the roller bearing, which is integral with the shaft, and the exterior ring, which is integral with the housing. The electric current which passes through the components of the roller bearing can damage these components, in particular the rolling elements and the raceways provided on the interior and exterior rings. The electrical discharges can also generate vibrations.

In order to eliminate these disadvantages, it is known to replace the rolling elements of the bearing made of the same steel as that of the interior and exterior rings by rolling elements made of ceramic. Reference is then generally made to a hybrid roller bearing. However, a hybrid roller bearing of this type is relatively costly.

In order to eliminate the aforementioned disadvantages, it is also known to equip the exterior ring of the roller bearing with an insulation sleeve having a bushing and an insulation lining made of electrically insulating material, and interposed radially between the exterior ring and the bushing. In order to secure the insulation lining on the exterior ring and on the bushing without an additional element or particular machining on the exterior ring, it is possible to over-mold the insulation lining. However, with a solution of this type, in operation, separation of the insulation lining and the bushing from one another may take place.

### SUMMARY

An aspect of the present disclosure is thus to remedy the aforementioned disadvantages by providing a bearing device with a simple and economical design. The disclosure concerns a bearing device comprising a bearing having a first ring and a second ring which can rotate relative to one another.

The device also comprises at least one insulation sleeve fitted on the second ring of the bearing. The insulation sleeve is having a bushing in a single piece and an insulation lining interposed radially between the second ring of the bearing and the bushing. The insulation lining is made of electrically insulating material. “Bushing in a single piece” means that the bushing is made as a single unit. The bushing is made as a single part.

The bushing comprises an exterior surface and an interior surface opposite the exterior surface, and which delimit the radial thickness of the bushing. The insulation lining is over-molded on the second ring of the bearing and at least on one of the exterior and interior surfaces of the bushing.

According to a general characteristic, the bushing comprises an axial portion delimiting the surface of the bushing on which the insulation lining is over-molded, and first and second flanges extending the axial portion radially on the side of the second ring. According to another general characteristic, the insulation lining is also over-molded on an inner face of each of the first and second flanges. According to another general characteristic, each of the first and second flanges of the bushing extends radially beyond an exterior or interior surface of the second ring on which insulation lining is over-molded.

The production of the bushing with flanges makes it possible to obtain good integration with the insulation lining. The risk of relative displacements between the insulation lining and the bushing in the axial direction is avoided in particular during variations of temperatures.

“Axial direction” means the direction parallel to the axis of the bearing device.

In addition, the fact of having first and second flanges of the bushing which extend radially beyond the exterior or interior surface of the second ring on which the insulation lining is over-molded makes it possible to obtain a bushing with good mechanical strength.

In fact, with an arrangement of this type, each part of the insulation lining which is situated axially between the second ring and one of the flanges of the bushing is not subjected to shearing stresses when substantial axial loads are applied to the device fitted in the interior of the housing of the motor or of the associated electrical machine, with one of these flanges supported against a shoulder of the housing. In fact, in this case, compression stresses are applied on this part of the insulation lining. This increases the reliability of the device.

The second ring is having first and second frontal faces delimiting its axial length. In a particular embodiment, the first flange of the bushing is offset axially towards the exterior in relation to the first frontal face of the second ring. Alternatively, or in combination, the second flange of the bushing can be offset axially towards the exterior in relation to the second frontal face of the second ring.

The insulation lining is having two frontal faces delimiting the axial length of the lining. According to a first design, at least one of the first and second flanges of the bushing can be flush axially with one of the frontal faces of the insulation lining. According to a second design, each of the first and second flanges of the bushing is flush axially with one of the frontal faces of the insulation lining. Alternatively, one of the flanges or each flange of the bushing can be offset axially towards the interior or towards the exterior in relation to the associated frontal face of the insulation lining.

According to a particular design, the surface of the bushing is having at least one groove extending in the circumferential direction, and in the interior of which a rib extends for coupling of the insulation lining with a complementary form. Thus, the axial coupling of the insulation lining on the bushing is increased further.

“Circumferential direction” means the direction which is perpendicular both to the axial direction and to a radius of the bearing device, in other words, tangent to a circle, the center of which is on the axis of the bearing device.

If the insulation lining is made of a synthetic material or an elastomer material, it makes it possible to make the device insensitive to the temperature variations. In a particular embodiment, the bushing is made of metal material. The bushing can thus be easily machined to a predetermined radial tolerance. Advantageously, the bushing is obtained from a sheet-metal flank by cutting, stamping and rolling.

According to one embodiment, the insulation lining covers all of the surface of the bushing. In this case, the insulation lining covers entirely the surface of the bushing in the axial direction and in the circumferential direction. According to a first design, the bushing delimits the exterior surface of the device. In this case, the second ring is the exterior ring of the bearing. According to a second alternative design, the bushing delimits the interior surface of the device. In this case, the second ring is the interior ring of the bearing.

In a particular embodiment, the bearing comprises at least one row of rolling elements positioned between raceways of the first and second rings. The rolling elements can be made of metal material.

The disclosure also concerns an electric motor comprising a housing, a shaft, and at least one bearing device as previously defined, fitted radially between the housing and the shaft.

According to an embodiment of the disclosure, a bearing device includes a bearing, a bushing and an electrically insulating insert overmolded between and connecting the bearing and the bushing. The bearing includes a first ring and a second ring configured to rotate relative to each other about a central axis, the first ring and the second ring each having a first cylindrical surface and a second cylindrical surface radially spaced from the first cylindrical surface, a first annular side surface and a second annular side surface and a maximum axial width. The bushing comprises an axially extending cylindrical portion and a first annular flange extending radially from a first axial end of the cylindrical portion and a second annular flange extending radially from a second axial end of the cylindrical portion, and a portion of the second ring is located axially between the first annular flange and the second annular flange. A minimum axial distance between the first annular flange and the second annular flange is greater than the maximum axial width of the second ring, and the electrically insulating insert is overmolded onto the cylindrical portion of the bushing and onto the first annular flange and onto the second annular flange and onto the second cylindrical surface of the second ring. The maximum axial width of the first ring is greater than the maximum axial width of the second ring, and an axial outer surface of the first annular flange is coplanar with the first annular side surface of the first ring and/or an axial outer surface of the second annular flange is coplanar with the second annular side surface of the first ring.

The disclosure also concerns a method for production of a bearing device as previously defined, comprising at least the following successive steps: radially positioning the second ring of the bearing relative to the surface of the bushing, with the bushing having in straight cross-section during this step the shape of an “L” formed by the first flange and by the axial portion; partially bending the axial portion, in order to form the second flange of the bushing; over-molding the insulation lining on the second ring and on the surface of the bushing and the inner face of each of the first and second flanges; and assembling the first ring of the bearing of the assembly formed by the second ring, the bushing and the insulation lining.

Advantageously, after the step of partial bending and before the step of over-molding, the method comprises a step of heat treatment of the bushing and of the second ring of the bearing positioned in one another.

### BRIEF DESCRIPTION OF THE DRAWINGS

The present disclosure will be better understood by studying the detailed description of embodiments, taken by way of non-limiting examples, and illustrated by the appended drawings in which:

FIG. 1 is a sectional elevational view of part of a bearing device according to an embodiment of the present disclosure.

FIG. 2 is a flowchart illustrating a method for producing the bearing device of FIG. 1.

FIGS. 3-6 are sectional elevational views of bearing elements during a manufacturing process that produces the bearing device of FIG. 1.

FIG. 7 is a sectional elevational view of part of a bearing device according to another embodiment of the present disclosure.

### DETAILED DESCRIPTION

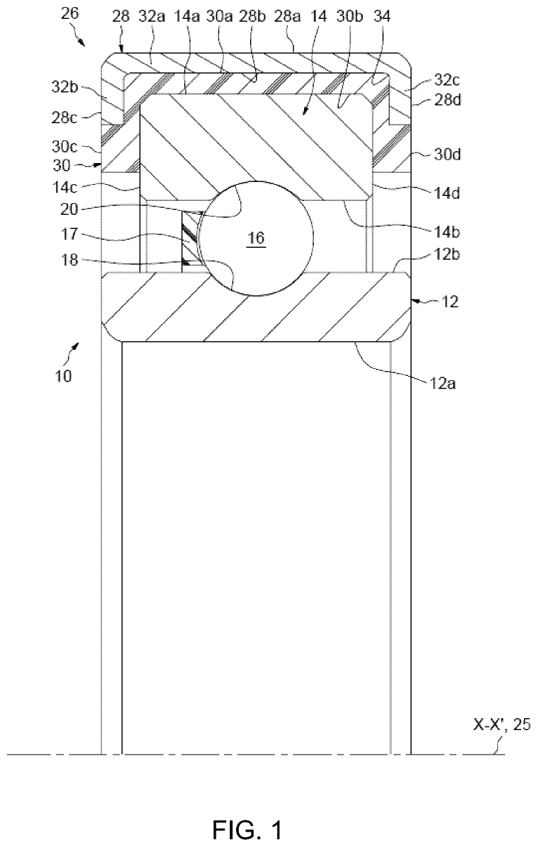

The bearing device illustrated in FIG. 1 comprises a bearing 10 having a first ring 12 and a second ring 14 which can rotate relative to one another around the axis X-X′ of the bearing. In the embodiment illustrated, the first ring 12 is the interior ring of the bearing and the second ring 14 is the exterior ring. The bearing device is designed such as not to conduct electric currents. The bearing device has integrated electrical insulation.

The interior 12 and exterior 14 rings of the bearing are concentric and extend axially along the axis X-X′ of the bearing. The interior 12 and exterior 14 rings are made of steel. The rings are of the solid type. In the embodiment illustrated, the bearing 10 also comprises a row of rolling elements 16, in this case balls, interposed radially between the interior 12 and exterior 14 rings. The rolling elements 16 are made of steel. The bearing 10 also comprises a cage 17 for maintenance of the regular circumferential spacing of the rolling elements 16. The bearing 10 can also be equipped with seals or sealing flanges.

The interior ring 12 comprises a cylindrical bore 12a, a cylindrical axial exterior surface 12b radially opposite the bore, and first and second opposite radial frontal faces (with no reference) delimiting axially the bore and the exterior surface. The bore 12a and the exterior surface 12b delimit the radial thickness of the interior ring 12. The bore 12a forms the interior surface of the interior ring. The first and second faces delimit the axial length of the interior ring 12.

The interior ring 12 also comprises an interior raceway 18 for the rolling elements 16, which is formed on the exterior surface 12b. The raceway 18 faces radially towards the exterior.

The exterior ring 14 comprises a cylindrical axial exterior surface 14a, a cylindrical bore 14b radially opposite the exterior surface 14a, and first and second opposite radial frontal faces 14c, 14d, delimiting axially the bore 14b and the exterior surface 14a. The exterior surface 14a and the bore 14b delimit the radial thickness of the exterior ring 14. The first and second faces 14c, 14d delimit the axial length of the exterior ring 14.

The exterior ring 14 also comprises an exterior raceway 20 for the rolling elements 16, which is formed on the bore 14b. The raceway 20 faces radially towards the interior.

The bearing device also comprises an electrical insulation sleeve 26 fitted on the exterior ring 14. The insulation sleeve 26 is fitted on the exterior surface 14a of the exterior ring 14. The insulation sleeve 26 is integral with the exterior ring 14.

The insulation ring 26 comprises a bushing 28 and an insulation lining 30 interposed radially between the exterior ring 14 and the bushing 28. The insulation lining 30 is over-molded on the exterior ring 14 and on the bushing 28.

The bushing 28 has an annular form. The bushing 28 is produced in a single piece. In this case, the bushing 28 is produced as a single part. Preferably, the bushing 28 is made of steel. The bushing 28 can advantageously be obtained from a sheet-metal flank by cutting, stamping and rolling. Alternatively, the bushing 28 can be obtained from a tube or from a forged and/rolled blank.

The bushing 28 comprises an axial portion 32a, and first and second annular radial flanges 32b, 32c each extending the axial portion radially towards the interior. Each flange 32b, 32c extends radially. Each flange 32b, 32c extends an axial end of the axial portion 32a. In the embodiment illustrated, the flanges 32b, 32c are annular. Alternatively, at least one of the flanges 32b, 32c could be in the form of sectors which are spaced from one another in the circumferential direction.

The bushing 28 comprises a cylindrical axial exterior surface 28a, and a cylindrical bore 28b radially opposite the exterior surface 28a, and the axis 25 of which is coaxial with the axis X-X′. The bore 28b forms the interior surface of the bushing 28. The axial portion 32a of the bushing delimits the exterior surface 28a and the bore 28b. The exterior surface 28a and the bore 28b delimit the radial thickness of the bushing 28. The exterior surface 28a of the bushing forms the exterior surface of the bearing device 10. In other words, the exterior surface 28a defines the exterior diameter of the bearing device 10.

The bushing 28 also comprises two opposite radial frontal faces 28c, 28d delimiting axially the axial length of the bushing. The frontal face 28c is delimited by the flange 32b, and the frontal face 28d is delimited by the flange 32c. More specifically, the frontal face 28c is delimited by the exterior flange face 32b, and the frontal face 28d is delimited by the exterior face of the flange 32c.

In the embodiment illustrated, the frontal faces 28c, 28d of the bushing are offset towards the exterior relative to the frontal faces 14c, 14d of the exterior ring. Alternatively, it would be possible to provide other arrangements. For example, the exterior ring 14 could have a larger axial dimension, and the frontal faces 28c, 28d of the bushing could be respectively coplanar with the frontal faces 14c, 14d of the exterior ring.

Each of the flanges 32b, 32c of the bushing extends radially beyond the exterior surface 14a of the exterior ring, i.e. projecting radially towards the interior in relation to the exterior surface 14a. In other words, the free end of each flange 32b, 32c is offset radially towards the interior in relation to the exterior surface 14a of the exterior ring. The flanges 32b, 32c remain axially spaced from the exterior ring 14.

In the embodiment illustrated, the radial dimensions of the flanges 32b, 32c of the bushing are equal. The flanges 32b, 32c of the bushing are symmetrical in relation to a median radial plane of the device. Alternatively, the radial dimension of the flange 32c of the bushing could be different from the radial dimension of the flange 32b.

In the embodiment illustrated, the bushing 28 also comprises an annular groove 34 provided in the area of connection between the axial portion 32a and the flange 32c on the side of the bore 28b. As will be described in greater detail hereinafter, this makes it possible to facilitate the formation of the flange 32c of the bushing.

The insulation lining 30 is made of electrically insulating material. The insulation lining 30 can for example be made of synthetic material such as a PEEK or a PA46, or it can also be made of an elastomer material, for example of rubber.

The insulation lining 30 is interposed radially between the exterior surface 14a of the exterior ring and the bore 28b of the bushing. The insulation lining 30 covers the exterior surface 14a of the exterior ring. The insulation lining 30 in this case covers entirely the exterior surface 14a of the exterior ring, taking into consideration the axial and circumferential directions. The insulation lining 30 also covers the frontal faces 14c, 14d of the exterior ring.

The insulation lining 30 also covers the bore 28b of the bushing. The insulation lining 30 in this case also covers entirely the bore 28b, taking into consideration the axial and circumferential directions. The insulation lining 30 covers the bore of the axial portion 32a of the bushing.

The insulation lining 30 also covers the inner face of each flange 32b, 32c of the bushing. The inner face and the outer face axially opposite the inner face of each flange 32b and 32c delimit the axial thickness of the flange. For each flange 32b and 32c, the inner face is oriented axially towards the interior of the device, and the outer face is oriented axially towards the exterior of the device. The insulation lining 30 also covers the free end (radially inner end) of each flange 32b, 32c of the bushing.

The insulation lining 30 has an annular form. The insulation lining 30 extends axially. The insulation lining 30 comprises a cylindrical axial exterior surface 30a, a cylindrical bore 30b radially opposite the exterior surface 30a, and two opposite radial frontal faces 30c, 30d delimiting axially the bore and the exterior surface. The radial frontal faces 30c, 30d delimit the insulation lining 30 axially. The exterior surface 30a and the bore 30b delimit the radial thickness of the insulation lining 30. The exterior surface 30a is in radial contact with the bore 28b of the bushing. The exterior surface 30a is also in radial contact with the free end of each flange 32b, 32c of the bushing. The exterior surface 30a has a stepped form. The bore 30b is in radial contact with the exterior surface 14a and with the frontal faces 14c, 14d of the exterior ring. The bore 30b has a stepped form.

In the embodiment illustrated, the faces 30c, 28c and 30d, 28d of the insulation lining and of the bushing are respectively coplanar. Alternatively, it is possible to provide other arrangements. For example, the bushing 28 could extend axially projecting from the insulation lining 30 in relation to the faces 30c and 30d, or it could remain axially recessed from these faces.

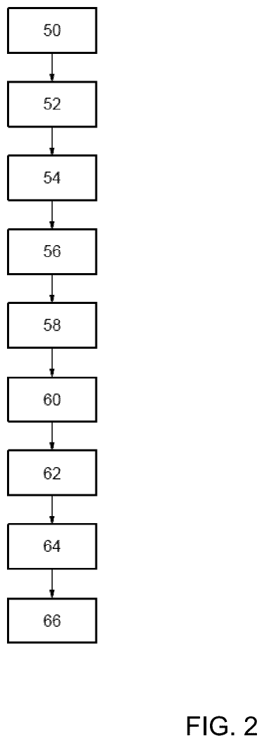

With reference to FIGS. 2 to 6, a description will now be provided of an example of the method for production of the bearing device.

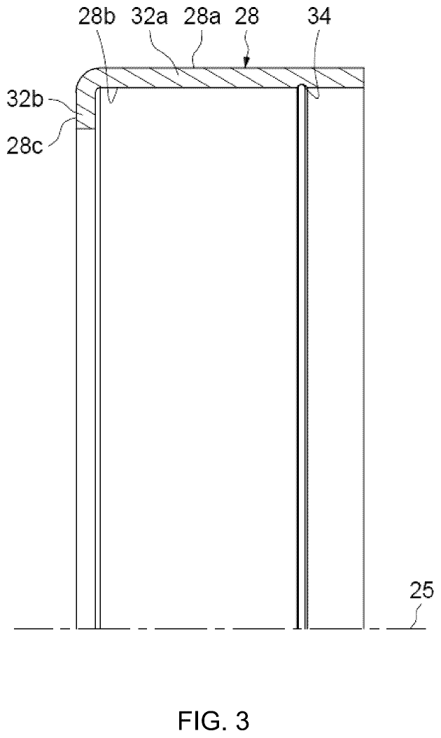

In a first step 50, the bushing 28 is formed so as to have the form of an “L” in straight cross-section, as illustrated in FIG. 3. At this stage, the bushing 28 comprises the flange 32b and the axial portion 32a. The axial portion 32a has an axial dimension larger than its final dimension, since the flange 32c is not yet formed, and is thus in the form of an axial extension which extends from the groove 34. The bushing 28 is formed for example by cutting and stamping.

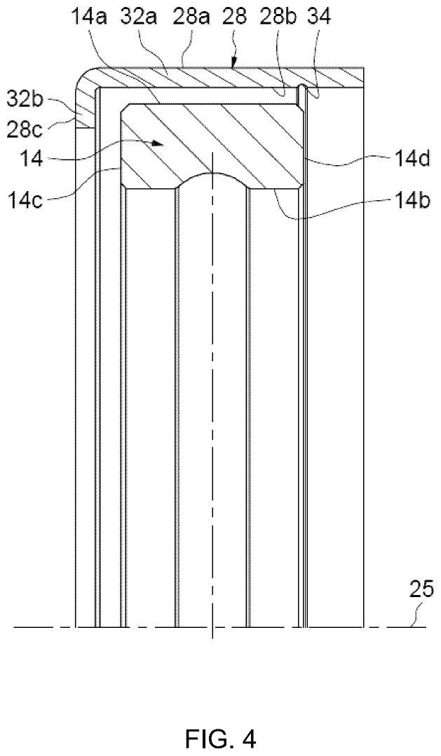

In a second, successive step 52, as illustrated in FIG. 4, the exterior ring 14 of the bearing is positioned radially in the interior of the bushing 28, which at this stage still has the form of an “L” in straight cross-section.

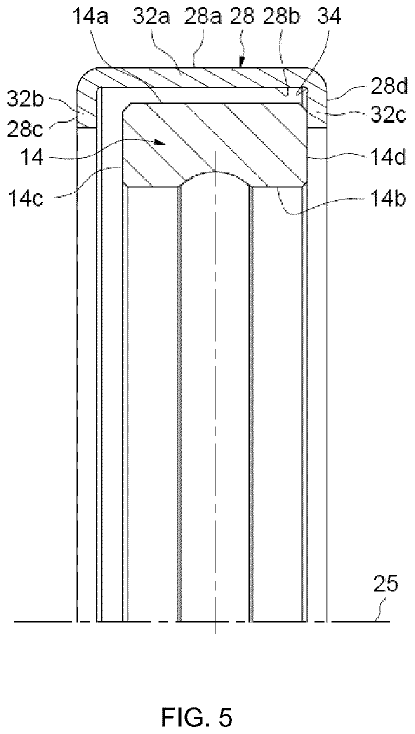

Then, in the third step 54, the axial portion 32a of the bushing is bent partially in order to form the flange 32c of the bushing, and thus obtain the final form of the bushing, which has the general form of a “U” in straight cross-section, as illustrated in FIG. 5. The flange 32c is formed for example by rolling. The flange 32c of the bushing is in this case bent until it is supported against the frontal face 14d of the exterior ring. The groove 34 facilitates the bending of the flange 32c of the bushing. Alternatively, it remains possible to provide other means to create a start of bending, for example the thickness of the flange 32c could be reduced in relation to the remainder of the bushing. In another variant, it remains possible not to provide such means in order to create a start of bending.

In a fourth successive step 56, the bushing 28 and the exterior ring 14 are subjected together to a step of heat treatment. The bushing 28 and the exterior ring 14 are thus heated together at the same temperature. The bushing 28 and the exterior ring 14 remain positioned in one another during this step, in the position illustrated in FIG. 5.

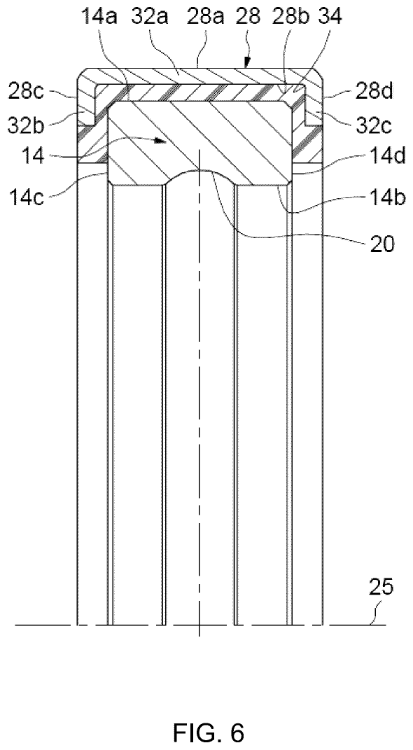

Then, in a fifth step 58, the bushing 28 and the exterior ring 14 of the bearing are fitted in the interior of a mold which is provided for the over-molding of the insulation lining 30. Next, in the sixth step 60, the insulation lining 30 is over-molded both on the exterior ring 14 and on the bushing 28, as illustrated in FIG. 6. In a seventh successive step 62, the unit assembly formed by the exterior ring 14, by the bushing 28 and by the insulation lining 30 is extracted from the mold.

Then, in an eighth step 64, the frontal faces 28c, 28d of the bushing are rectified. During this step, the exterior surface 28a of the bushing and the raceway 20 of the exterior ring can also be rectified. Finally, in a ninth step 66, the unit assembly formed by the exterior ring 14, the bushing 28 and the insulation lining 30 is assembled with the row of rolling element 16, the cage 17 and the interior ring 12.

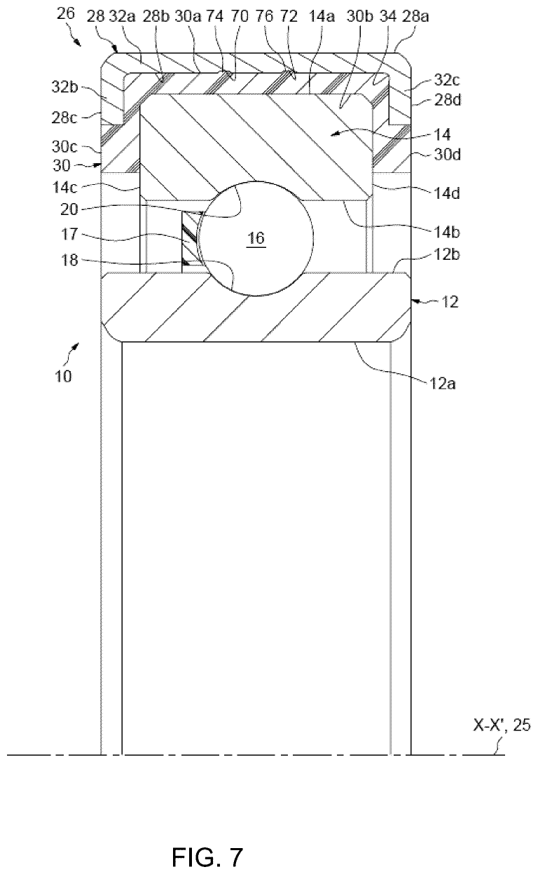

The embodiment illustrated in FIG. 7, in which identical elements bear the same references, differs from the preceding example in that the bore of the axial portion 32a of the bushing is having two axially spaced grooves 70, 72, which extend circumferentially around the axis 25 of the bore of the bushing. Each groove 70, 72 is oriented radially on the side of the outer ring 14, i.e. radially towards the interior.

In the embodiment illustrated, each groove 70, 72 is annular. Alternatively, at least one of the two grooves 70, 72 need not extend around 360°, or can also be formed by a succession of spirals extending circumferentially and spaced from one another in the circumferential direction.

Each groove 70, 72 is delimited in the axial direction by two facing lateral flanks which have a straight profile in axial cross-section, and are connected to one another by an axial base. Alternatively, it is possible to provide other forms, for example grooves which in this case in straight cross-section have a form of an arc of a circle oriented towards the interior.

The insulation lining 30 also comprises two ribs 74, 76 which extend radially towards the exterior from the exterior surface 30a, and are each accommodated in the interior of one of the grooves 70, 72 of the bushing. The rib 74, 76 has a form complimentary to the associated groove 70, 72. Each rib 74, 76 extends projecting relative to the exterior surface 30a of the insulation lining. Each rib 74, 76 is formed on the exterior surface 30a during the over-molding of the insulation lining 30.

In the embodiments illustrated, the first ring 12 of the bearing is the interior ring, and the second ring 14 on which the insulation lining 30 is over-molded is the exterior ring.

Alternatively, it is possible to provide an inverted arrangement in which the second ring 14 on which the insulation lining 30 is over-molded is the interior ring. In this case, the insulation sleeve is situated in the bore 12a of the interior ring. The insulation lining is thus interposed radially between the bore 12a of the interior ring and the exterior surface of the bushing. The insulation lining is over-molded on the interior ring and at least on the exterior surface of the bushing. The bore of the bushing delimits the bore of the bearing device. The flanges of the bushing extend radially beyond the interior surface of the interior ring, in other words the bore of the interior ring, i.e. they extend projecting radially towards the exterior in relation to the interior surface of the interior ring.

In the embodiments described, the bearing of the device is having a single row of rolling elements. As a variant, the bearing can be having a plurality of rows of rolling elements. In addition, the roller bearing can comprise types of rolling elements other than balls, for example rollers. In another variant, the bearing can be a plain bearing without rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electrically insulated bearing assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other about a central axis, the first ring and the second ring each having a first cylindrical surface and a second cylindrical surface radially spaced from the first cylindrical surface, a first annular side surface and a second annular side surface and a maximum axial width,
a bushing, and
an electrically insulating insert overmolded between and connecting the bushing and the second cylindrical surface of the second ring,
wherein the bushing comprises an axially extending cylindrical portion and a first annular flange extending radially from a first axial end of the cylindrical portion and a second annular flange extending radially from a second axial end of the cylindrical portion,
wherein a portion of the second ring is located axially between the first annular flange and the second annular flange,
wherein a minimum axial distance between the first annular flange and the second annular flange is greater than the maximum axial width of the second ring,
wherein the electrically insulating insert is overmolded onto the cylindrical portion of the bushing and onto the first annular flange and onto the second annular flange and onto the second cylindrical surface of the second ring,
wherein the maximum axial width of the first ring is greater than the maximum axial width of the second ring, and
wherein an axial outer surface of the first annular flange is coplanar with the first annular side surface of the first ring and/or an axial outer surface of the second annular flange is coplanar with the second annular side surface of the first ring.

2. The bearing device according to claim 1,
wherein the first annular flange is axially spaced from the first annular side surface of the second ring by a first portion of the electrically insulating material and the second annular flange is axially spaced from the second annular side surface of the second ring by a second portion of the electrically insulating material.

3. The bearing device according to claim 2,
wherein an axially outer surface of the first flange is coplanar with a first axially outer surface of the electrically insulating insert, and
wherein an axially outer surface of the second flange is flush with a second axially outer surface of the electrically insulating material.

4. The bearing device according to claim 3,
wherein a first surface of the cylindrical portion of the bushing faces the second cylindrical surface of the second ring,
wherein the first surface of the cylindrical portion of the bushing includes a circumferentially extending groove, and
wherein a rib of the electrically insulating material extends into the groove.

5. The bearing device according to claim 4,
wherein the bushing is made of metal.

6. The bearing device according to claim 5,
wherein the bushing comprises bent sheet metal.

7. An electric motor comprising:
a housing,
a shaft, and
at least one bearing device according to claim 1 fitted radially between the housing and the shaft.

8. A method for producing a bearing device comprising:
providing a sheet metal cylinder having a first radially extending flange,
providing a bearing ring having a first axial end surface connected to a second axial end surface by a cylindrical surface,
positioning the bearing ring so that the cylindrical surface of the bearing ring faces the sheet metal cylinder and at least a portion of the first axial end surface of the bearing ring faces the first radially extending flange,
after the positioning, bending an edge of the sheet metal cylinder axially opposite the first radially extending flange to form a second radially extending flange such that at least a portion of the second radially extending flange faces the second axial end surface of the bearing ring,
overmolding a body of electrical insulation on the cylindrical surface of the bearing ring and on a surface of the sheet metal cylinder facing the cylindrical surface of the bearing ring and on a surface of the first radially extending flange facing the second radially extending flange and on a surface of the second radially extending flange facing the first radially extending flange, and
after the overmolding, assembling the bearing ring with another bearing ring to form a bearing.

9. The method according to claim 8,
wherein the bending comprises bending the edge of the sheet metal cylinder against the second axially end surface of the bearing ring.

10. The method according to claim 8,
including after the bending and before the overmolding, heat treating the bushing and the bearing ring simultaneously.
